(19) United States
(12) Patent Application Publication
(10) Pub. No.: US 2026/0260121 A1
(43) Pub. Date: Sep. 3, 2026

(54) MODEL-FREE REINFORCEMENT LEARNING WITH REGULARIZED NASH DYNAMICS

(71) Applicant: DeepMind Technologies Limited, London (GB)

(72) Inventors: Julien Perolat, Saint Etienne (FR); Bart De Vylder, Lokeren (BE); Karl Paul Tuyls, Le Mesnil-le-Roi (FR)

(21) Appl. No.: 18/878,470

(22) PCT Filed: Jun. 27, 2023
(86) PCT No.: PCT/EP2023/067491

§ 371 Date: Dec. 23, 2024

Related U.S. Application Data
(60) Provisional application No. 63/356,009, filed on Jun. 27, 2022.

(51) Int. Cl. G06N 3/092

(52) U.S. Cl. CPC G06N 3/092

(57) ABSTRACT

Methods, systems, and apparatus, including computer programs encoded on a computer storage medium, for training a policy neural network that is used to control an agent. In particular, the policy neural network can be trained through model-free reinforcement learning with regularized Nash dynamics.

### CROSS-REFERENCE TO RELATED APPLICATION

This application claims priority to U.S. Provisional Application No. 63/356,009, filed on Jun. 27, 2022. The disclosure of the prior application is considered part of and is incorporated by reference in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations that controls an agent interacting with an environment to perform a task in the environment using a policy neural network.

This specification also describes techniques for training the policy neural network so that the policy neural network can be used to effectively control the agent.

More specifically, this specification describes techniques for training the policy neural network over multiple training phases using a technique that is referred to as “Regularized Nash Dynamics.”

There is described a computer-implemented method of training a policy neural network used to control an agent interacting with an environment, and optionally one or more other agents, to perform a task.

The method initializes a regularized control policy, e.g. arbitrarily, for controlling the agent. The method involves a plurality of training phases. The regularized control policy may define, deterministically or stochastically, an action to be performed in response to an observation. The regularized control policy can generally be any appropriate control policy for controlling the agent that assigns a non-zero score to at least some of the actions in the set and uses the scores to select the action that the agent will perform. At at least some of the training phases from a plurality of training phases and as will be described below, the regularized control policy depends on weights determined for the policy neural network in the preceding training phase.

Each of a plurality of training phases can involve generating training data for the task, the training data comprising, for each of a plurality of steps during a trajectory of performing the task (i.e. a sequence of actions), a tuple comprising data identifying (i) an observation, (ii) an action performed in response to the observation in the tuple, and (iii) a reward for the task. For actions performed by the agent the actions performed may be determined by processing the observation using the policy neural network to generate a policy output for selecting the action. In implementations other actions may be performed by one or more other agents.

The method involves generating modified training data for a modified task by, for each tuple generating a transformed reward from the reward in the tuple using the regularized control policy as of the (current) training phase. In some implementations a preceding regularized control policy (from a preceding training phase) can also be used. Generating the transformed reward can involve using the regularized control policy to compute a modifier that is applied to the reward to obtain the transformed reward. The modifier can be determined, e.g., from a (logarithm of a) ratio of a probability assigned to an action by the policy neural network and a probability assigned to the action by the regularized policy. A degree of the modification of a reward by the modifier can be determined by a regularization parameter (having a value greater than zero), e.g. that multiplies the modifier. With multiple agents the modifier for the agent controlled by the policy neural network may have an opposite sign to that for the other agent(s).

The method generates a modified tuple comprising data identifying (i) the observation identified the tuple, (ii) the action identified in the tuple and (iii) the transformed reward for the tuple, and the policy neural network is trained on the modified training data. For example the policy neural network can be trained using a reinforcement learning technique based on the transformed rewards, e.g. by updating parameters, such as weights, of the policy neural network using a reinforcement learning objective that depends on the transformed rewards, using an optimizer (a gradient descent optimization algorithm) such as Adam. The method can perform multiple (interleaved) iterations of generating the training data and/or modifying training data, and training the policy neural network, in a training phase before updating the regularized control policy, e.g. by controlling the agent to act in the environment after training the policy neural network, to obtain more training data.

After training the policy neural network the regularized control policy is updated to be a policy that selects actions using the policy neural network. That is, the control policy defined by the trained policy neural network (at the end of a training phase) defines the regularized control policy. For example a regularized policy neural network can be maintained, corresponding to the policy neural network, and its parameters, e.g. weights, can be updated to be the same as the updated weights of the policy neural network as of the completion of the training phase. In implementations the regularized control policy is used to regularize the rewards and also results from regularization of the rewards.

Particular embodiments of the subject matter described in this specification can be implemented so as to realize one or more of the following advantages.

By training the neural network as described in this specification, the system can train the neural network to perform well even on tasks that have a very large state space, a very large action space, or both.

Moreover, the system can train the neural network to perform well even in multi-agent scenarios that have imperfect information (in addition to large state and/or action spaces), in which observations convey both “private” information and “public” information and other agents' “private” information is not available to the agent that is acting.

In particular, the system trains the policy neural network by repeatedly performing training phases in which the system directly modifies the underlying learning dynamics by training the neural network on a modified task that is defined by modified rewards that are computed using a regularization policy.

By modifying the dynamics, the system modifies the task so that the policy neural network can effectively learn a high-quality control policy even in the presence of imperfect information, very large state spaces, very large action spaces, or some combination of the three. For example, the modified rewards can steer a reinforcement learning technique used to train the policy neural network in the direction of a Nash equilibrium. By updating the regularization policy using the trained policy neural network and repeating the training process with rewards modified using updated regularization policy, the system can iteratively get closer to a Nash equilibrium, in particular without needing to explicitly model private states of other agents. In broad terms, the described techniques allow the training to converge, even in astronomical state or action spaces characterized by imperfect information.

In particular, the system can train the policy neural network to learn a high-quality control policy without requiring any demonstration data, which can be difficult to obtain in sufficient amounts for complex real-world tasks or other tasks with large state spaces, and without requiring a model of the environment, which can be difficult to generate or learn for complex environments.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example action selection system.

FIG. 2 is a flow diagram of an example process for training the policy neural network.

FIG. 3 is a flow diagram of an example process for performing a training phase.

FIG. 4 is a flow diagram of an example process for generating a transformed reward.

FIG. 5 shows an example architecture of the policy neural network.

FIG. 6A shows one example training architecture for the training system.

FIG. 6B shows another example training architecture for the training system.

Like reference numbers and designations in the various drawings indicate like elements.

### DETAILED DESCRIPTION

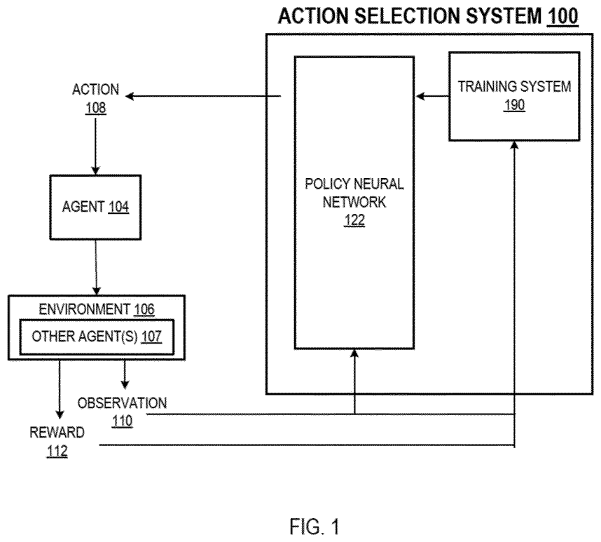

FIG. 1 shows an example action selection system 100. The action selection system 100 is an example of a system implemented as computer programs on one or more computers in one or more locations in which the systems, components, and techniques described below are implemented.

The action selection system 100 controls an agent 104 that is interacting in an environment 106 to perform a task by selecting actions 108 to be performed by the agent 104 and then causing the agent 104 to perform the actions 108.

The agent can receive a respective reward 112 at each time step, where the reward is specified by a scalar numerical value and characterizes, e.g., a progress of the agent towards completing an assigned task.

As a particular example, the reward 112 can be a sparse binary reward that is zero unless the task is successfully completed as result of the action being performed, e.g., is only non-zero, e.g., equal to one, if the task is successfully completed as a result of the action performed.

As another particular example, the reward 112 can be a dense reward that measures a progress of the agent towards completing the task as of individual observations received during the episode of attempting to perform the task, e.g., so that non-zero rewards can be and frequently are received before the task is successfully completed.

In particular, at each time step, the system 100 receives an observation 110 that characterizes the state of the environment at the time step.

The system 100 then processes an input that includes the observation 110 using a policy neural network 122.

The policy neural network 122 is configured to receive an input that includes an observation 110 characterizing a state of the environment 106 and to process the input to generate a policy output that defines the action 104 to be performed in response to the observation.

For example, the policy neural network 122 can generate a policy output that assigns a respective score to each action in a set of actions that can be performed by the agent 104. In this example, the system can, e.g., select the action with the highest score or map the scores to a probability distribution and then sample an action from the probability distribution.

As another example, to select the action 104, the policy neural network 122 can generate a policy output that includes parameters of a score distribution over the set of actions, e.g., parameters of a Gaussian distribution over a continuous space of possible actions. In this example, the system can, e.g., select the action that represents the mean of the distribution or sample an action from the distribution.

As yet another example, the set of actions can include multiple subsets, e.g., with the actions in each subset being valid actions during a different portion of the steps required to perform the task.

In this example, the policy neural network 122 can include multiple “policy heads,” with each “policy head” corresponding to a different subset of actions and generating a respective output that either (i) assigns a respective score to each action in the corresponding subset or (ii) includes parameters that define a score distribution over the actions in the corresponding subset.

In this example, to select the action 104, the system can select one of the subsets and then select an action using the output of the head corresponding to the subset, e.g., as described above. For example, each subset can be valid at a different set of time steps during an episode of performing the task or can be valid at a different set of environment states. The system can then select the subset and the corresponding head based on the current time step or the current environment state at the current time step.

The policy neural network 122 can have any appropriate architecture that allows the neural network 122 to map data that is in the format of the input to a policy output. For example, the policy neural network 122 can include one or more of convolutional layers, fully-connected layers, recurrent layers, attention layers, and so on.

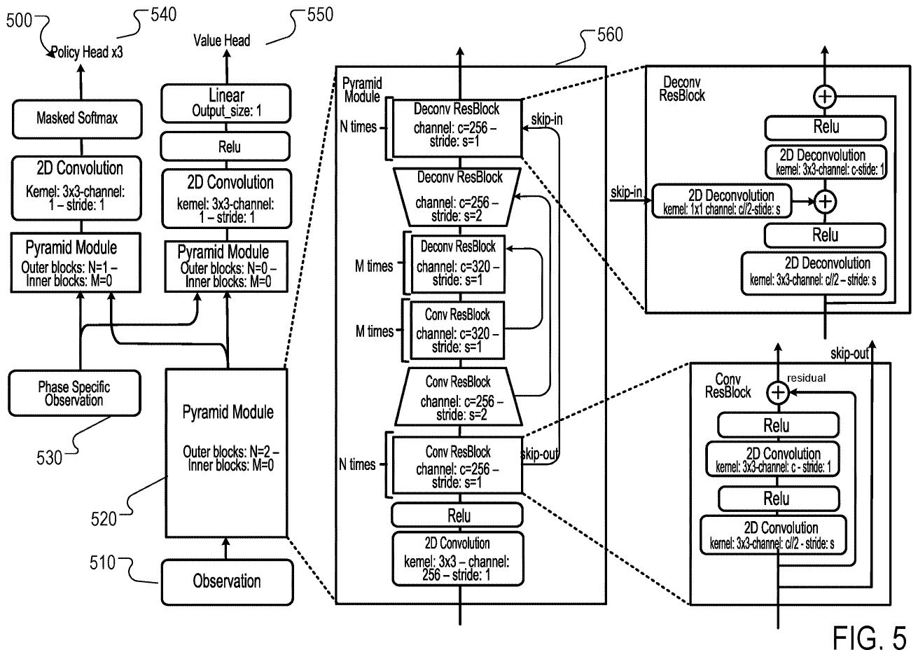

One example architecture is described in more detail below with reference to FIG. 5.

In some implementations, performing the task may require the agent 104 to interact with one, two, or more other agents 107 in the environment 106 that are also performing the same task or performing one or more other tasks.

Operation of the other agents 107 may be controlled by a computer-implemented method, e.g., similar to that controlling the agent 104, or some or all may be partly or wholly under human control. That is, the other agents can also be controlled using an instance of the policy neural network 122 (or a different learned policy) or by a fixed computer-implemented policy.

In general the tasks performed by the agent 104 and the other agents may have the same character, e.g., they may all be routing tasks, navigation tasks, assembly tasks, and so on, or they may all be scheduling tasks, or they may all be manufacturing tasks.

The other tasks may be the same as, or different to, the task of the agent 104.

The tasks performed by the agents may contribute to achieving a common goal or may be adversarial, i.e., the tasks performed by the other agents may work to impede the agent 104 from performing the task.

In general, the ability of the agent 104 to perform the task in the environment is affected by the one or more other agents performing the one or more other tasks in the environment.

In some implementations where the agent 104 interacts with other agents, different agents can perform actions at different time steps during a given episode of performing a task. That is, for a proper subset (i.e. a subset that is less than all) of the time steps in a task episode, the action that is performed in the environment is an action performed by the agent 104 in response to the observation 110 at the time step. For each of the time steps in the trajectory that is not in the proper subset, one of the one or more other agents performs an action.

As a particular example, when the agent 104 interacts with a single other agent, the agent 104 and the other agent can perform actions at alternating time steps.

Alternatively, different agents can perform actions at the same time step, i.e., two or more agents can perform a respective action at the same time step.

Additionally, in some implementations where the agent 104 interacts with other agents, the observation received at a given time step by each action can include different information.

That is, the observation 110 can include (i) public information about the state of the environment 106 that is available to the agent 104 and the one or more other agents 107 and (ii) private information about the state of the environment 106 that is only available to the agent that performs the action in response to the observation 110.

For example, public information about the state of the environment 106 includes information that can be measured by the sensors of all of the agents in the environment at a given time step. Public information can also include static information about the environment that is provided to all of the agents, e.g., a map of the environment or other data characterizing static properties of the environment.

Private information can include, e.g., information that can only be measured by the sensor of a single agent, e.g., proprioceptive sensor readings or sensor readings from sensors internal to an agent. Private information can also include information characterizing the task being performed by the agent, e.g., a conditioning input that instructs the agent about which task to perform, e.g., a natural language statement characterizing the goal of the agent or a goal image characterizing a goal state of the environment.

In some implementations, the observation 110 includes a public information tensor that includes the public information at the given time step and a private information tensor that includes the private information at the given time step. Separating the private and public information in this manner can allow the neural network 122 to learn how to effectively incorporate these two different types of information.

Further, in some implementations, the public information includes information about the agent 104 that is public and can be observed by other agents 107. That is, the public information in the observation 110 can provide the agent 104 with knowledge about the public information that is available to the other agents 107 about the state of the agent 104 at the given time step.

As will be described below, in some implementation, the observation 110 includes history information from previous time steps or the policy neural network 122 is otherwise conditioned on information from previous time steps, e.g., by virtue of including one or more recurrent neural network layers. In these implementations, for any given agent that is acting at a time step and is controlled by the policy neural network, the system conditions the policy neural network 122 only on public history information and the given agent's private history information, and not on private history information from any other agents.

The system 100 also includes a training system 190 that trains the policy neural network 122 so that the policy neural network 122 can be used to effectively control the agent 104.

In implementations, the training system 190 trains the policy neural network 122 over multiple training phases through model-free reinforcement learning using a technique that is referred to as “Regularized Nash Dynamics.”

The training performed by training system 190 is referred to as “model-free” reinforcement learning because the training system 190 uses a reinforcement learning technique that does not use an explicit model of the environment, i.e., that models the effects of actions performed by the agent 104 and the other agents 107 on the state of the environment.

By training the policy neural network 122 as described herein, the policy neural network 122 can effectively learn a high-quality control policy even in the presence of imperfect information (i.e., when other agents' private information is not observable to the acting agent), very large state spaces, very large action spaces, or some combination of the three.

As will be described below, during training, the one or more other agents 107 may also be controlled by the policy neural network 122 in order to generate the training data for the training.

After training, the other agents 107 can be controlled by different policies, e.g., by human-operated controllers or by controllers controlled by different software, or can continue to be controlled by instances of the policy neural network 122.

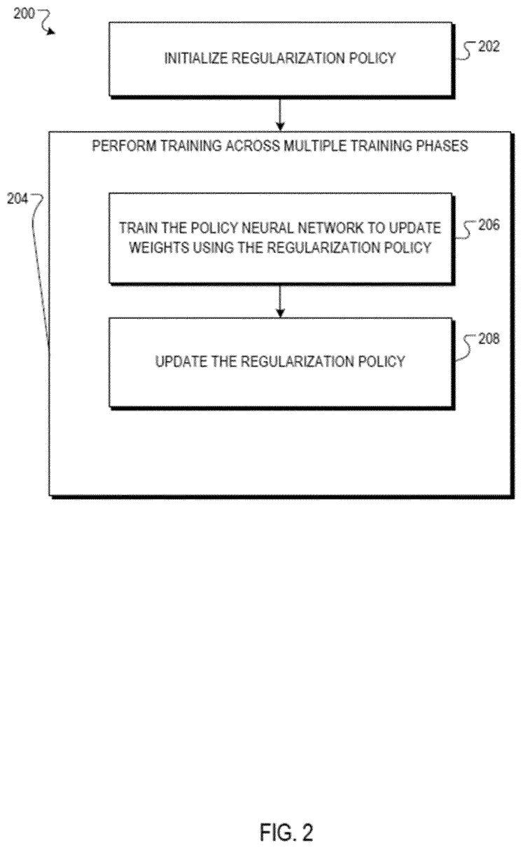

Training is described in more detail below with reference to FIGS. 2-4.

In some implementations, the environment is a real-world environment, the agent is a mechanical agent interacting with the real-world environment, e.g., a robot or vehicle, e.g. an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate an object of interest in the environment or to move an object of interest to a specified location in the environment or to navigate to a specified destination in the environment.

As another example the agent controlled by the policy neural network may be a vehicle, e.g., with or without a human driver, and the agent may be controlled by using the policy neural network to control traffic signals, such as traffic lights and lane control signals, that the driver is obliged to obey. Where present the one or more other agents may also be mechanical agents such as robots or human-driven or autonomous or semi-autonomous vehicles, e.g. making up a fleet of vehicles. Thus some implementations of the system can be used to control traffic, e.g. road traffic, or warehouse robots, or aircraft such as drones, to facilitate a smooth flow of the traffic.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment. In some traffic control applications the observations may include map data that depicts the static objects in the environment, e.g., roads, trees, building, etc., and/or live road condition data that depicts non-static objects in the environment, e.g., pedestrians, other vehicles, the status of road signals e.g. color of the traffic lights, and so forth.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements, e.g., steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation, e.g., steering, and movement, e.g., braking and/or acceleration of the vehicle. In a traffic control setting the actions can also or instead include physical movements, e.g., moving forward, taking left or right turn, yielding, and so forth, and signaling actions, e.g. sending messages or signals to another agent to show an intention of the agent. In such a setting processing one or more historical observations as well as a current observation can be useful in indicating a historical relationship between agents, e.g. vehicles. The rewards may indicate whether the agent has accomplished a task, e.g., navigating to a target location in the environment, or the progress of the agent towards accomplishing the task, or some other measure such as a speed of progress of the agent, energy or fuel used, estimated time to a destination, relative order of arrival at a destination compared with another vehicle, and so forth. Where used, an assumed reward of another agent may correspond to one or more of these.

In some implementations the environment is a simulation of the above-described real-world environment, and the agent is implemented as one or more computers interacting with the simulated environment. For example the simulated environment may be a simulation of a robot or vehicle and the reinforcement learning system may be trained on the simulation and then, once trained, used in the real-world.

In some implementations the environment is a real-world manufacturing environment for manufacturing a product, such as a chemical, biological, or mechanical product, or a food product. As used herein “manufacturing” a product also includes refining a starting material to create a product, or treating a starting material, e.g., to remove pollutants, to generate a cleaned or recycled product. The manufacturing plant may comprise a plurality of manufacturing units such as vessels for chemical or biological substances, or machines, e.g., robots, for processing solid or other materials. The manufacturing units are configured such that an intermediate version or component of the product is moveable between the manufacturing units during manufacture of the product, e.g., via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g., minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment, e.g., between the manufacturing units or machines. In general the actions may be any actions that have an effect on the observed state of the environment, e.g., actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g., a metric of a quantity of energy, materials, or other resources, used to perform the task. In the case of a task that is to control use of a resource the metric may comprise any metric of usage of the resource.

In general observations of a state of the environment may comprise any electronic signals representing the functioning of electronic and/or mechanical items of equipment. For example a representation of the state of the environment may be derived from observations made by sensors sensing a state of the manufacturing environment, e.g., sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions, e.g., a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g., data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control, e.g., cooling equipment, or air flow control or air conditioning equipment. The task may comprise a task to control, e.g., minimize, use of a resource, such as a task to control electrical power consumption, or water consumption. The agent may comprise an electronic agent configured to control operation of the items of equipment, or to control operation of the ancillary, e.g., environmental, control equipment.

In general the actions may be any actions that have an effect on the observed state of the environment, e.g., actions configured to adjust any of the sensed parameters described below. These may include actions to control, or to impose operating conditions on, the items of equipment or the ancillary control equipment, e.g., actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example in the case of a task to control, e.g., minimize, use of a resource, such as a task to control use of electrical power or water, the metric may comprise any metric of use of the resource.

In some implementations the environment is the real-world environment of a power generation facility, e.g., a renewable power generation facility such as a solar farm or wind farm. The task may comprise a control task to control power generated by the facility, e.g., to control the delivery of electrical power to a power distribution grid, e.g., to meet demand or to reduce the risk of a mismatch between elements of the grid, or to maximize power generated by the facility. The agent may comprise an electronic agent configured to control the generation of electrical power by the facility or the coupling of generated electrical power into the grid. Where there are multiple agents, each may control the generation of electrical power by a different respective power generating entity, e.g. facility or part of a facility. The actions may comprise actions to control an electrical or mechanical configuration of an electrical power generator such as the electrical or mechanical configuration of one or more renewable power generating elements, e.g., to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g., an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such sensors may include sensors configured to sense electrical conditions of the equipment such as current, voltage, power or energy; temperature or cooling of the physical environment; fluid flow; or a physical configuration of the equipment; and observations of an electrical condition of the grid, e.g., from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In a similar way the environment may be a drug design environment such that each state is a respective state of a potential pharmaceutically active compound and the agent is a computer system for determining elements of the pharmaceutically active compound and/or a synthetic pathway for the pharmaceutically active compound. The drug/synthesis may be designed based on a reward derived from a target for the drug, for example in simulation. As another example, the agent may be a mechanical agent that performs or controls synthesis of the drug.

As further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g., an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e., observations of a mechanical shape or of an electrical, mechanical, or electro-mechanical configuration of the entity, or observations of parameters or properties of the entity. The actions may comprise actions that modify the entity, e.g., that modify one or more of the observations. The rewards or return may comprise one or more metric of performance of the design of the entity. For example rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g., in the form of computer executable instructions for manufacturing the entity. The process may include making the entity according to the design. Thus the design of an entity may be optimized, e.g., by reinforcement learning, and then the optimized design output for manufacturing the entity, e.g., as computer executable instructions; an entity with the optimized design may then be manufactured. As another particular the agent(s) may be routing agent(s) configured to route interconnection lines of an integrated circuit, the observations may be of component positions and interconnections, the actions may be routing actions e.g. interconnect or component selection and/or placement actions, and the reward(s) may depend on routing metric(s) such as interconnect length, resistance, capacitance, impedance, loss, speed or propagation delay, and/or physical line parameters such as width, thickness or geometry, and design rules. After the routing the integrated may be manufactured with the routed interconnection lines.

In some applications the one or more agents is/are software agents and the environment is a real-world computing environment. In one example the agent(s) manage distribution of tasks across computing resources e.g. on a mobile device and/or in a data center. In these applications, the observations may include observations of computing resources such as compute and/or memory capacity, or Internet-accessible resources; and the actions may include assigning tasks to particular computing resources. The reward(s) may be configured to maximize or minimize one or more of: utilization of computing resources, electrical power, bandwidth, and computation speed.

In another example the software agent(s) manage the processing, e.g. by one or more real-world servers, of a queue of continuously arriving jobs. The observations may comprise observations of the times of departures of successive jobs, or the time intervals between the departures of successive jobs, or the time a server takes to process each job, e.g. the start and end of a range of times, or the arrival times, or time intervals between the arrivals, of successive jobs, or data characterizing the type of job(s). The actions may comprise actions that allocate particular jobs to particular computing resources; the reward(s) may be configured to minimize an overall queueing or processing time or the queueing or processing time for one or more individual jobs, or in general to optimize any metric based on the observations.

In some applications, the environment is a real-world computing environment and the software agent(s) manage distribution of tasks/jobs across computing resources e.g. on a mobile device and/or in a data center. In these implementations, the observations may comprise observations that relate to the operation of the computing resources in processing the tasks/jobs, the actions may include assigning tasks/jobs to particular computing resources, and the reward(s) may relate to one or more metrics of processing the tasks/jobs using the computing resources, e.g. metrics of usage of computational resources, bandwidth, or electrical power, or metrics of processing time, or numerical accuracy, or one or more metrics that relate to a desired load balancing between the computing resources.

In some applications the environment is a data packet communications network environment, and the one or more agents is/are part of one or more routers to route packets of data over the communications network. The actions may comprise data packet routing actions and the observations may comprise e.g. observations of a routing table which includes routing metrics such as a metric of routing path length, bandwidth, load, hop count, path cost, delay, maximum transmission unit (MTU), and reliability. The reward(s) may be defined in relation to one or more of the routing metrics i.e. configured to maximize one or more of the routing metrics.

As previously described the environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

Optionally, in any of the above implementations, the observation at any given step may include data from a previous step that may be beneficial in characterizing the environment, e.g., the action performed at the previous step, the reward received at the previous step, or both.

In some implementations, performing the task may require the agent to interact with one, two, or more other agents in the environment that are also performing the same task or performing one or more other tasks. Operation of the other agents may be controlled by a computer-implemented method, e.g., similar to that controlling the first agent, or some or all may be partly or wholly under human control.

In general the tasks may have the same character, e.g., they may all be routing tasks, navigation tasks, assembly tasks, and so on, or they may all be scheduling tasks, or they may all be manufacturing tasks. The other tasks may be the same as, or different to, the task of the first agent. The tasks performed by the agents may contribute to achieving a common goal or may be adversarial, i.e., the tasks performed by the other agents may work to impede the agent from performing the task. In typical implementations the ability of the first agent to perform the task in the environment is affected by the one or more other agents performing the one or more other tasks in the environment.

FIG. 2 is a flow diagram of an example process 200 for training the policy neural network. For convenience, the process 200 will be described as being performed by a system of one or more computers located in one or more locations. For example, an action selection system, e.g., the action selection system 100 of FIG. 1, appropriately programmed in accordance with this specification, can perform the process 200.

In particular, the system initializes a regularization policy (step 202). Generally, the regularization policy is a policy that assigns a respective (non-zero) likelihood to each of the actions in the set of actions.

The regularization policy can be initialized as any arbitrary policy that assigns a non-zero likelihood to some or all of the actions in the set of actions. For example, the regularization policy can be a uniform policy that assigns the same score to each action or can be a random policy that assigns a random score to each action.

After initializing the regularization policy, the system performs the training across multiple training phases (also referred to as “stages”) (step 204).

At each training phase, the system trains the policy neural network to update the weights of the policy neural network using the regularization policy as of the training phase (step 206).

For example, before the system trains the policy neural network at the first training phase, the system can initialize the weights of the policy neural network using an appropriate machine learning initialization technique.

For each subsequent training phase, the system can train the policy neural network starting from the weights determined at the preceding training phase, i.e., without resetting the values of the weights between training phases.

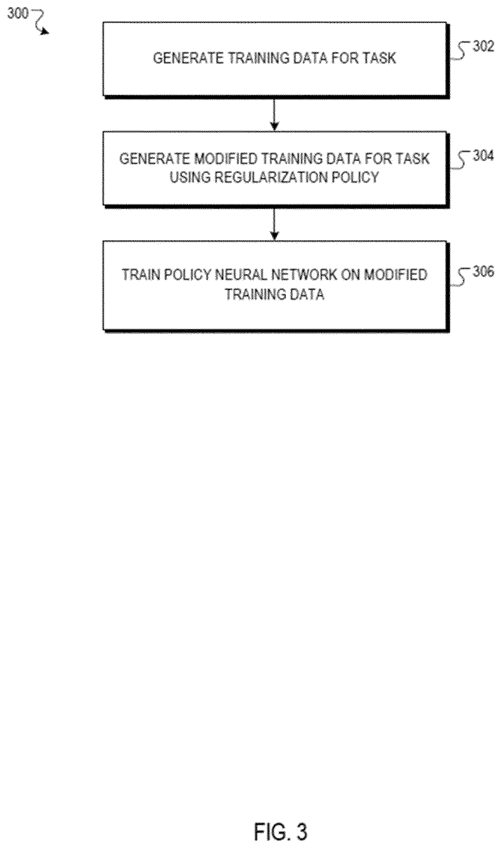

Performing a training phase using a regularization policy is described below with reference to FIG. 3.

At the completion of each training phase, the system updates the regularization policy (step 208).

In particular, the system updates the regularization policy to be equal to a policy that controls the agent using the policy neural network as of the completion of the training phase, i.e., a policy neural network that has the updated weights that have been determined as of the completion of the training phase or a policy neural network that has target weights that are determined as of the completion of the training phase. “Target weights” refers to weights that are computed as moving averages of the weights as the weights are updated during the training phase.

A policy that controls the agent using the policy neural network can be one that, e.g., samples actions according to scores generated by the policy neural network, adds noise to the scores generated by the policy neural network and then samples actions using the noisy scores, and so on.

FIG. 3 is a flow diagram of an example process 300 for performing a training phase. For convenience, the process 300 will be described as being performed by a system of one or more computers located in one or more locations. For example, an action selection system, e.g., the action selection system 100 of FIG. 1, appropriately programmed in accordance with this specification, can perform the process 200.

At each training phase, the system generates training data for the task that reflects the results of performing one or more action trajectories while performing the task (step 302).

An action trajectory can include data for some or all of the steps in performing an episode of the task.

An episode is a period of interaction during which the agent attempts to perform the task, i.e., the period that starts from an initial state for the task and continues until the agent successfully completes the task, interacts with the environment for a threshold number of steps, or satisfies a different termination criterion.

For example, each trajectory can include data for all of the steps in an episode or can include up to a maximum number of steps from an episode.

Thus, the training data includes, for each of a plurality of steps in a trajectory of performing the task, a tuple that includes data identifying (i) an observation, (ii) an action performed in response to the observation in the tuple, and (iii) a reward for the task.

For example, the system can generate each trajectory by controlling the agent using the policy neural network over the course of a task episode.

When the task requires a multi-agent interaction, the system can also control the other agent(s) interacting in the environment using the policy neural network.

Thus, in these cases, for a proper subset of the steps in the trajectory, the action is an action performed by the agent in response to the observation, and, for each of the plurality of steps in the trajectory that is not in the proper subset, the action is an action performed by one of the one or more other agents in response to the observation in the tuple.

Thus, the actions in different tuples at different steps in a trajectory can be actions performed by different agents.

Moreover, for each tuple, the reward for the task identified in the tuple is a reward for the agent that performed the action in response to the observation. In some cases, the tuple also includes data identifying (value of) respective rewards or assumed rewards for each agent other than the agent that performed the action in response to the tuple. For example, when two agents are performing adversarial tasks, the reward for the agent that did not act at a given step can be the negative of, i.e., equal in magnitude but with the opposite sign to, the reward for the agent that did act at the given step.

The system generates, from the training data, modified training data for a modified task (step 304).

More specifically, for each tuple, the system generates a transformed reward from the reward in the tuple using the regularized control policy as of the training phase and generates a modified tuple that includes data identifying (i) the observation identified the tuple, (ii) the action identified in the tuple and (iii) the transformed reward for the tuple.

When there are multiple agents and multiple rewards per tuple, the system can generate a respective transformed reward for each reward in the tuple, i.e., for each of the agents for each step in the trajectory.

Thus, the system modifies the “dynamics” of the task to generate a modified task, i.e., one in which acting in the environment results in the transformed reward being received (rather than the actual reward in the original training data).

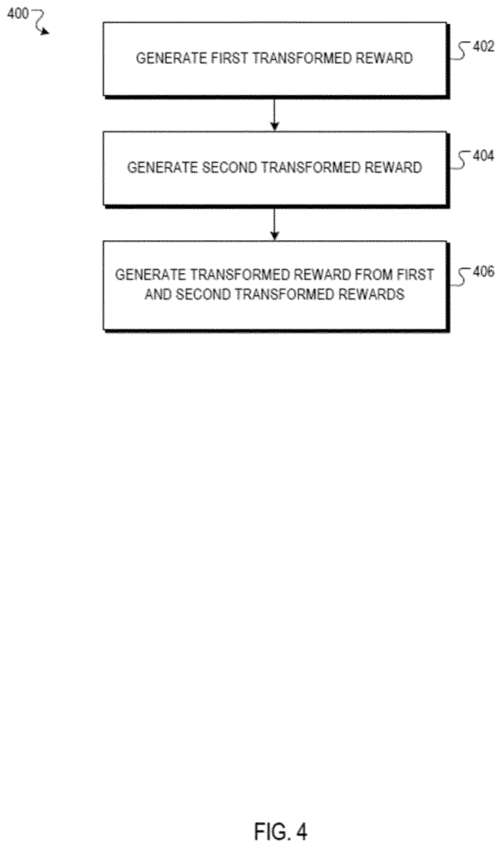

Modifying a reward using the regularized control policy is described in more detail below with reference to FIG. 4.

Generating the modified training data can be referred to as the “reward transformation” stage of the training phase.

The system then trains the policy neural network on the modified training data, e.g., on an objective that measures expected transformed rewards, through reinforcement learning (step 306).

For example, the objective can be to maximize expected returns, where returns are computed as sums or time-discounted sums of expected future transformed rewards. When there are multiple agents, the objective can be to maximize expected returns for each agent, where returns are computed as sums or time-discounted sums of expected future transformed rewards for the agent.

Training the policy neural network (and optionally a critic neural network) can be referred to as the dynamics stage of the training phase.

Generally, the system can train the policy neural network on the modified training data using any appropriate reinforcement learning technique.

As a particular example, the system can train the policy neural network jointly with a critic neural network using an actor-critic reinforcement learning technique.

The critic neural network is a neural network that is configured to receive an observation and to process the observation to generate a predicted value for the observation, where the predicted value is a prediction of the return that will be received (in terms of transformed rewards) starting from the environment being in the state characterized by the observation.

For example, the critic neural network can be implemented as a separate output head of the policy neural network that generates the value prediction given the input observation to the policy neural network.

In particular, in this example, the system computes, for each trajectory, a respective value estimate for each step in the trajectory that is an estimate of a combination, e.g. sum or a time-discounted sum, of future transformed rewards received after the environment was in the state characterized by the tuple in the step and then trains the policy neural network and the critic neural network using the transformed rewards and the respective value estimates for the steps in each of the trajectories.

When there are multiple agents, the system computes, for each trajectory, respective value estimates for each agent for each step in the trajectory that is an estimate of a combination of future transformed rewards for the agent received after the environment was in the state characterized by the tuple in the step and then trains the policy neural network and the critic neural network using the transformed rewards and the respective value estimates for the agents for the steps in each of the trajectories.

In some implementations, the system computes the respective value estimates for each agent, e.g. recursively, starting from the last step in the trajectory and continuing until a first step in the trajectory, i.e., using the transformed rewards and outputs generated by the policy neural network and the critic neural network. Computing the value estimates in this way can reduce bias. For example, the system can compute the respective value estimates for each agent using a V-Trace estimator, e.g. as described in Espeholt et al. arXiv:1802.01561.

In some implementations, to further reduce bias, even when trajectories are less than the length of a full episode, the system can compute the value estimates using data from the full episode, i.e., without any bootstrapping. One example technique for computing estimates across the full episode when trajectories are shorter than full episodes is described below.

In some implementations, when computing the value estimate using the V-Trace estimator, the system uses target values of the weights of the policy neural network and the critic neural network. For example, the target values can be maintained as moving averages of the current values of the weights during the training phase.

For example, the system can train the critic neural network using the respective value estimates and train the policy neural network using a loss that depends on outputs generated by the critic neural network, e.g., that depends on the value estimates, Q function estimates, or both generated using the critic neural network.

As a particular example, but not essentially, the system can train the policy neural network through a Neural Replicator Dynamics (NeuRD) loss that is computed based on outputs generated by the critic neural network. The NeuRD loss is described in more detail in D. Hennes, et al., Proceedings of the International Conference on Autonomous Agents and Multiagent Systems (AAMAS) (2020). For example the NeuRD loss can be a loss that is dependent upon a sum over possible actions, of a gradient with respect to weights of the policy neural network of a metric of (i) a difference between the policy output for an observation at a step in a trajectory and a target value, e.g. an average over actions of the policy output for the observation and (ii) an advantage estimate for the action that is computed using the value estimates and measures the relative advantage (in terms of estimated return computed from transformed rewards) of performing the action in response to the observation relative to performing a different action from the set.

When there are multiple agents, for each step, the system can compute a loss only for the agent that acted at the step when training the policy neural network on the NeuRD loss. For example, the overall loss can be the average NeuRD loss across all the time steps in the trajectory.

To train the critic neural network, the system can train the neural network on a regression loss that measures, for each step in each trajectory, an error between the respective value estimate for the step and a predicted value generated by processing the observation in the tuple for the step using the critic neural network.

When there are multiple agents, for each step, the system can use only the value estimate for the agent that acted at the step when training the critic neural network on the regression loss. For example, the regression loss can be the average squared error across all the time steps in the trajectory.

Generally, within a given training phase, the system can interleave the training and the generating of the training data, i.e., so that at each of multiple training steps the neural network is trained using some or all of the training data that has already been collected as of the training step.

Thus, by interleaving performing iterations of steps 302 to 306 during the training phase, different tuples will be generated in accordance with different weights of the policy neural network.

Alternatively, the system can first generate all of the training data for the training phase and then train the policy neural network on the training data.

Upon completion of the phase, the system updates the regularization policy using the policy neural network as described above.

By repeatedly performing these training phases in which the system directly modifies the underlying learning dynamics by training the neural network on the modified task, the system can train the neural network to perform well even on tasks that have a very large state space, a very large action space, or both. Moreover, the system can train the neural network to perform well even in multi-agent scenarios that have imperfect information (in addition to large state and/or action spaces), in which observations convey both “private” information and “public” information and other agents' “private” information is not available to the agent that is acting.

Thus, the training technique is referred to as “Regularized Nash Dynamics” because, at each training stage, the system learns a policy that (approximately) converges to a fixed point for the modified task defined by the modified training data that is generated using the regularization policy.

In some implementations, after performing the process 300 for each of the multiple training phases, the system fine-tunes the policy neural network using a modified training technique.

For example, the system can fine-tune the policy neural network by applying a different projection to the logits, i.e., the action scores, generated by the policy neural network, when computing the value estimates used in the training. For example, the system can fine-tune the training with a different projection that thresholds and discretizes the action probabilities using a specified threshold level and number of probability quanta. This threshold level and the number of probability quanta can be hyperparameters of the training process. Performing this fine-tuning can help reduce low-probability mistakes made by the policy neural network as a result of the softmax projection assigning non-zero probabilities to every action in the space.

FIG. 4 is a flow diagram of an example process 400 for modifying a reward for a given step in a trajectory using a regularization policy. For convenience, the process 400 will be described as being performed by a system of one or more computers located in one or more locations. For example, an action selection system, e.g., the action selection system 100 of FIG. 1, appropriately programmed in accordance with this specification, can perform the process 400.

The system generates a first transformed reward from the reward at the given step using the regularized control policy as of the training phase (step 402).

To generate the first transformed reward, the system computes a ratio of (i) a probability assigned to the action performed by the agent at the step by the policy neural network (in accordance with the weights at the time at which the action was selected) and (ii) a probability assigned to the action performed by the agent at the step by the regularized policy.

The system then computes a modifier from this ratio.

As one example, the system can compute the modifier based on a product of a regularization parameter and a logarithm of the ratio.

The regularization parameter can be a hyperparameter of the training and governs how strongly the regularization policy impacts the actual reward. For example a larger regularization parameter can result in more stable and faster convergence during training of the policy neural network in a single training phase, but can provide a bias towards the regularized control policy that may imply slower overall training to convergence over multiple training phases.

The system then applies the modifier to the reward for the agent to generate the first transformed reward. For example, when the agent that received the reward was the agent that acted at the step, the system can subtract the modifier to the reward to generate the first transformed reward. When the agent that received the reward was not the agent that acted at the step, the system can add the modifier to the reward to generate the first transformed reward.

In some cases, the system sets the transformed reward to be equal to the first transformed reward.

In some other cases, the system smooths the transition from one regularization policy to another between training phases by also incorporating the regularization policy from the preceding training phase into computing the modified reward. For the first training phase, i.e., where there is no preceding training phase, the system can set the regularization policy from the preceding training phase equal to the regularization policy for the first training phase.

In particular, in these cases, the system generates a second transformed reward using a preceding regularized control policy from the preceding training phase (step 404). That is, the system can compute the second transformed reward in the same manner as the first transformed reward, but using the preceding regularized control policy from the preceding training phase in place of the regularized control policy for the current training phase.

The system then generates the transformed reward by combining the first and second transformed rewards (step 406). For example, the system can compute a weighted sum of the first and second transformed rewards to generate the transformed reward.

In some implementations in which multiple training iterations are performed during a training phase, the weights in the weighted sum can be dependent on the iteration, with iterations that occur later during the training of the policy neural network assigning higher weights to the first transformed reward. Generally, each training iteration corresponds to an update to the weights of the policy neural network during the training phase. For example, each training iteration can correspond to training the neural network on a batch of training data (or a set of multiple batches of training data in parallel, e.g., in the SIMD architecture described below) during the training iteration.

In some of these implementations, after a threshold training iteration, the system no longer uses the second transformed reward and sets the transformed reward equal to the first transformed reward.

For example, the weight assigned to the first transformed reward can be equal to the minimum of one and a constant value a, e.g., two, three, or four, multiplied by the ratio of the index of the current iteration to the total number of iterations. The weight assigned to the second transformed reward can be equal to one minus the weight assigned to the first transformed reward. Thus, in this example, once training is more than 1/a complete during a given training phase, the system stops using the second transformed reward and sets the transformed rewards equal to the first transformed rewards.

As some particular examples, in some implementations the transformed reward can be generated by adding to, or subtracting from, a reward a term

$$η log \frac{π ( a \vert 0 )}{{π}_{r e g} ( a \vert 0 )}$$

where η is a regularization parameter, π(a|o) is an action selection policy defined by the policy neural network (e.g. an action probability a for an observation, or history of observations, o), and π_{reg} (a|o) is the regularized control policy. Merely as an example η may be in the range 0 to 1, e.g. 0.2. In some implementations the term added to or subtracted from the reward can be ηγ(a|o) where

$$Υ ( a \vert o ) = a log \frac{π ( a \vert o )}{{π}_{reg , curr} ( a \vert o )} + ( 1 - a ) log \frac{π ( a \vert o )}{{π}_{reg , prev} ( a \vert o )}$$

where π_{reg,curr} is the current regularized control policy and π_{reg,prev} is a preceding regularized control policy, and a interpolates between these, e.g. as a=min (1,2n/Δₘ) for iteration n of Δₘ total iterations.

FIG. 5 shows an example architecture of the policy neural network 122.

In the example of FIG. 5, the policy neural network 122 includes a neural network torso 520 and three policy neural network heads 540.

Further, in the example of FIG. 5, the critic neural network is implemented as a value head 550 that receives the output of the neural network torso 520.

As shown in FIG. 5, the torso 520 processes an observation 510 to generate, as output, an embedding of the state of the environment.

Each of the policy neural network heads 540 and the value head 550 is configured to receive an input that includes the embedding of the state of the environment and to process the input to generate a respective output, e.g., a respective policy output or a value estimate.

As described above, when the policy neural network 122 includes multiple policy heads 540, each policy head corresponds to a different subset of actions in the set.

In this example, to select the action, the system can select one of the subsets and then select an action using the output of the head corresponding to the subset, e.g., as described above. For example, each subset can be valid at a different “phase” of the task, e.g., a different set of time steps during an episode of performing the task or can be valid at a different set of environment states.

Optionally, the system can also receive a phase specific observation 520 that is also provided as input to the heads 540 and 550. The phase specific observation 520 can include different types of data for different phases of the task. For example, the data can be at different levels of granularity for the different phases, e.g., a higher-level of granularity at the beginning of the task and a lower-level of granularity at the end of the task.

In the example of FIG. 5, the policy neural network 122 is a convolutional neural network. More specifically, in the example of FIG. 5, the torso 520 and the heads 540 and 550 each include a respective pyramid module 560 that includes a “pyramid” of convolutional neural network layers, e.g., with convolutional residual blocks (“convresblocks”) followed by deconvolutional residual blocks (“deconvresblocks”).

More generally, the policy neural network 122 can have a different type of convolutional architecture or an architecture with different types of neural network layers, e.g., recurrent layers, attention layers, and so on.

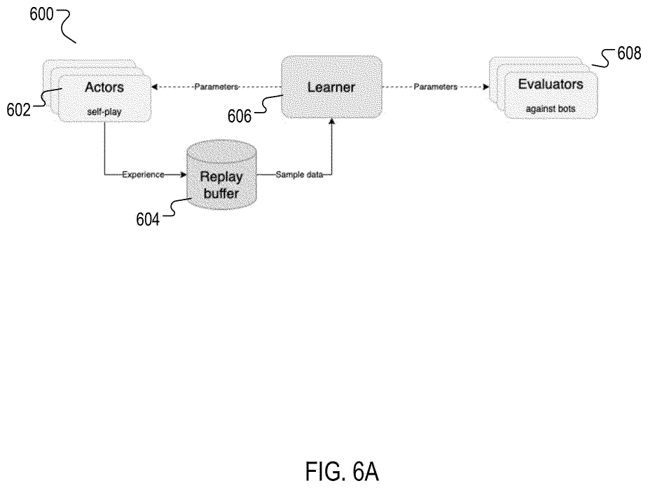

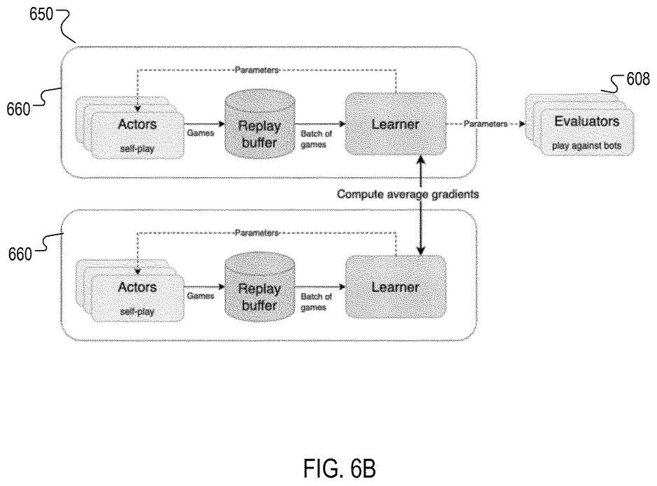

FIG. 6A shows one example training architecture for the training system for performing a training phase.

As shown in FIG. 6A, during the training phase, multiple actors 602 independently and asynchronously generate training data (“experience”) using the policy neural network 122 as described above and store the generated training data in a replay buffer memory 604. For example, the actors can use “self-play” where all agents in the environment are controlled by the policy neural network 122. A single learner 606 repeatedly samples training data from the replay buffer memory 604 and uses the training data to train the policy neural network 122 as described above. The learner 606 then periodically sends the updated weights (“parameters”) generated as a result of the training to the actors 602 so that the actors 602 can use the updated weights to generate additional training data.

The actors 602 and the learner 606 can be implemented in a variety of configurations. For example, each actor 602 can be implemented on a respective machine and the learner 606 can be implemented on a different machine.

As another example, all of the actors 602 and the learner 606 can be implemented on the same machine. In this example, the actors 602 can be implemented as software that primarily uses CPU resources, the buffer 604 can primarily use RAM or other device memory, while the learner 606 uses primarily resources provided by machine learning hardware accelerator of the machine.

Optionally, the training system 190 can also include one or more evaluators 608 that evaluate the performance of the policy neural network 122. As shown in the example of FIG. 6A, the evaluators 608 can evaluate the performance of the policy neural network 122 by controlling the other agents using different control policies (“bots”).

FIG. 6B shows another example training architecture for the training system for performing a training stage.

As shown in FIG. 6B, during the training phase, the system makes use of multiple learner machines 660 to scale the training pipeline using a single instruction multiple data (SIMD) model.

In this example, several learner machines 660 participate in training and each machine 660 implements multiple actors 602, a buffer 604, and a learner 606. The actors 602 within each machine 660 asynchronously generate training data as described above. Additionally, the learner 606 within each machine 660 does a learning step in sync with the learners 606 from the other machines 660: each reads a batch of different training data from the corresponding buffer 604 and computes network parameter gradients; the system 190 then computes the average of the gradients across all machines 660; and finally each learner 606 applies those average gradients, as updates, to network weights.

As described above, in some implementations, to further reduce bias, even when trajectories are less than the length of a full episode, the system can compute the value estimates using data from the full episode, i.e., without any bootstrapping. One example technique for computing these estimates in the configuration 600 or 650 when episodes are variable length will now be described.

Computing the exact returns on a variable-length trajectory requires to store full episodes in the Replay Buffer (instead of a fixed length sequences of time-steps). When the learner 606 samples a batch of episodes, shorter episodes are padded to the length of the longest episode in the batch. The batch is chopped into a variable number of fixed length chunks along the time-axis. The learner 606 then does two passes over this list of chunks: a) a forward pass to recompute the exact policy for each time-step and trajectory statistics; b) a backward pass, where each chunk is reprocessed again, but is given the exact network state at the beginning of the chunk and full trajectory statistics, such as the exact returns, and so on. Note that (a) happens outside of gradients computation, and serves to avoid bootstrapping or any kind of approximation for both the returns and for the network state. While (b) happens within the loss and serves to compute gradients for network weights.

The gradients computed on each chunk during (b) are accumulated, and applied using an optimizer onto the network weights at the end of the (b) pass.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

1. A method of training a policy neural network used to control an agent interacting with an environment to perform a task, the method comprising:
initializing a regularized control policy for controlling the agent; and
at each of a plurality of training phases, performing operations comprising:
generating training data for the task, the training data comprising, for each of a plurality of steps during a trajectory of performing the task, a tuple comprising data identifying (i) an observation, (ii) an action performed in response to the observation in the tuple, and (iii) a reward for the task;
generating, from the training data, modified training data for a modified task, comprising, for each tuple:
generating a transformed reward from the reward in the tuple using the regularized control policy as of the training phase, and
generating a modified tuple comprising data identifying (i) the observation identified the tuple, (ii) the action identified in the tuple and (iii) the transformed reward for the tuple; and
training the policy neural network on the modified training data; and
after training the policy neural network, updating the regularized control policy to be a policy that selects actions using the policy neural network.

2. The method of claim 1, wherein the environment includes one or more other agents and performing the task requires interacting with the one or more other agents.

3. The method of claim 2, wherein:
for a proper subset of the steps in the trajectory, the action is an action performed by the agent in response to the observation, and
for each of the plurality of steps in the trajectory that is not in the proper subset, the action is an action performed by one of the one or more other agents in response to the observation in the tuple.

4. The method of claim 3, wherein the observation at each step represents (i) public information about the state of the environment that is available to the agent and the one or more other agents and (ii) private information about the state of the environment that is only available to the agent that performs the action in response to the observation.

5. The method of claim 2, wherein, for each tuple, the reward for the task identified in the tuple is a reward for the agent that performed the action in response to the observation and wherein the tuple further comprises data identifying respective rewards for each agent other than the agent that performed the action in response to the tuple.

6. The method of claim 2, wherein generating the training data comprises controlling the agent to perform episodes of the task using the policy neural network.

7. The method of claim 6, wherein:
for a proper subset of the steps in the trajectory, the action is an action performed by the agent in response to the observation, and
for each of the plurality of steps in the trajectory that is not in the proper subset, the action is an action performed by one of the one or more other agents in response to the observation in the tuple, and wherein generating the training data comprises controlling the agent to perform episodes of the task using the policy neural network while also controlling the one or more other agents using the policy neural network.

8. The method of claim 1, wherein training the policy neural network on the modified task comprises training the policy neural network on an objective that measures expected transformed rewards through reinforcement learning.

9. The method of claim 8, wherein training the policy neural network comprises training the policy neural network jointly with a critic neural network that is configured to receive an observation and to process the observation to generate a predicted value for the observation, and wherein the training comprises:
for each trajectory, computing a respective value estimate for each step in the trajectory that is an estimate of a combination of future transformed rewards received after the environment being in the state characterized by the tuple in the step; and
training the policy neural network and the critic neural network using the transformed rewards and the respective value estimates for the steps in each of the trajectories.

10. The method of claim 9, wherein training the critic neural network comprises training the critic neural network using a regression loss that measures, for each step in each trajectory, an error between the respective value estimate for the step and a predicted value generated by processing the observation in the tuple for the step using the critic neural network.

11. The method of claim 9, wherein training the policy neural network and the critic neural network using the transformed rewards and the respective value estimates for the steps in each of the trajectories comprises training the policy neural network through a Neural Replicator Dynamics (NeuRD) loss.

12. The method of claim 1, wherein generating a transformed reward from the reward in the tuple using the regularized control policy comprises:
generating a first transformed reward using the regularized control policy.

13. The method of claim 12, wherein generating a transformed reward from the reward in the tuple using the regularized control policy comprises:
generating a second transformed reward using a preceding regularized control policy from a preceding training phase; and
generating the transformed reward by combining the first and second transformed rewards.

14. The method of claim 13, wherein generating the transformed reward by combining the first and second transformed rewards comprises:
computing a weighted sum of the first and second transformed rewards.

15. The method of claim 12, wherein generating a first transformed reward using the regularized control policy comprises:
computing a modifier based on a ratio of (i) a probability assigned to the action performed by the agent at the step by the policy neural network and (ii) a probability assigned to the action performed by the agent at the step by the regularized policy; and
applying the modifier to the reward for the agent.

16. The method of claim 15, wherein applying the modifier to the reward for the agent comprises:
subtracting the modifier from the reward.

17. The method of claim 15, wherein the modifier is based on a product of a regularization parameter and a logarithm of the ratio.

18. The method of claim 9, wherein computing a respective value estimate for each step in the trajectory comprises:
computing the respective value estimates recursively starting from a last step in a trajectory and continuing until a first step in the trajectory.

19. The method of claim 1, wherein the policy neural network is configured to receive an input comprising an observation characterizing a state of the environment and generate a policy output that defines an action from a set of actions to be performed in response to the observation.

20-29. (canceled)

30. A system comprising:
one or more computers; and
one or more storage devices communicatively coupled to the one or more computers, wherein the one or more storage devices store instructions that, when executed by the one or more computers, cause the one or more computers to perform operations for training a policy neural network used to control an agent interacting with an environment to perform a task, the operations comprising:
initializing a regularized control policy for controlling the agent; and
at each of a plurality of training phases, performing operations comprising:
generating training data for the task, the training data comprising, for each of a plurality of steps during a trajectory of performing the task, a tuple comprising data identifying (i) an observation, (ii) an action performed in response to the observation in the tuple, and (iii) a reward for the task;
generating, from the training data, modified training data for a modified task, comprising, for each tuple:
generating a transformed reward from the reward in the tuple using the regularized control policy as of the training phase, and
generating a modified tuple comprising data identifying (i) the observation identified the tuple, (ii) the action identified in the tuple and (iii) the transformed reward for the tuple; and
training the policy neural network on the modified training data; and
after training the policy neural network, updating the regularized control policy to be a policy that selects actions using the policy neural network

31. One or more non-transitory computer storage media storing instructions that when executed by one or more computers cause the one or more computers to perform operations for training a policy neural network used to control an agent interacting with an environment to perform a task, the operations comprising:
initializing a regularized control policy for controlling the agent; and
at each of a plurality of training phases, performing operations comprising:
generating training data for the task, the training data comprising, for each of a plurality of steps during a trajectory of performing the task, a tuple comprising data identifying (i) an observation, (ii) an action performed in response to the observation in the tuple, and (iii) a reward for the task;
generating, from the training data, modified training data for a modified task, comprising, for each tuple:
generating a transformed reward from the reward in the tuple using the regularized control policy as of the training phase, and
generating a modified tuple comprising data identifying (i) the observation identified the tuple, (ii) the action identified in the tuple and (iii) the transformed reward for the tuple; and
training the policy neural network on the modified training data; and
after training the policy neural network, updating the regularized control policy to be a policy that selects actions using the policy neural network
